(19) United States
(12) Patent Application Publication
(10) Pub. No.: US 2007/0122041 A1
(43) Pub. Date: May 31, 2007

(54) Spectral method for sparse linear discriminant analysis

(76) Inventors: Baback Moghaddam, Cambridge, MA (US); Yair Weiss, Jerusalem (IL); Shmuel Avidan, Brookline, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/440,825

(22) Filed: May 25, 2006

Related U.S. Application Data
(63) Continuation-in-part of application No. 11/289,343, filed on Nov. 29, 2005.

(51) Int. Cl. G06K 9/62; G06K 9/52; G06K 9/46

(52) U.S. Cl. 382/224; 382/206; 382/190

(57) ABSTRACT

A computer implemented method maximizes candidate solutions to a cardinality-constrained combinatorial optimization problem of sparse linear discriminant analysis. A candidate sparse solution vector x with k non-zero elements is inputted, along with a pair of covariance matrices A, B measuring between-class and within-class covariance of binary input data to be classified, the sparsity parameter k denoting a desired cardinality of a final solution vector. A variational renormalization of the candidate solution vector x is performed with regards to the pair of covariance matrices A, B and the sparsity parameter k to obtain a variance maximized discriminant eigenvector \hat{x} with cardinality k that is locally optimal for the sparsity parameter k and zero-pattern of the candidate sparse solution vector x, and is the final solution vector for the sparse linear discriminant analysis optimization problem. Another method solves the initial problem of finding a candidate sparse solution by means of a nested greedy search technique that includes a forward and backward pass. Another method, finds an exact and optimal solution to the general combinatorial problem by first finding a candidate by means of the previous nested greedy search technique and then using this candidate to initialize a branch-and-bound algorithm which gives the optimal solution.

### RELATED APPLICATION

This application is a continuation-in-part of U.S. patent application Ser. No. 11/289,343, “Spectral Method for Sparse Principal Component Analysis,” filed by Moghaddam et al. on Nov. 29, 2005.

### FIELD OF THE INVENTION

This invention relates generally to linear discriminant analysis (LDA), and more particularly to applying sparse LDA to practical applications such as gene selection, portfolio optimization, sensor networks, resource allocation, as well as general feature or variable subset selection in machine learning and pattern recognition.

### BACKGROUND OF THE INVENTION

Two classic techniques for dimensionality reduction and data classification are principal component analysis (PCA) and linear (Fisher) discriminant analysis (LDA). PCA finds a set of linear combinations or projections of input features (measurements) such that the new derived components are uncorrelated while capturing the maximal data variance within the least number of components.

LDA attempts to find a linear combination of features that best separate data into two classes. The linear combinations can be used for dimensionality reduction prior to classification, just as in PCA but with a different purpose, i.e., best classification accuracy as opposed to maximal variance capture.

Alternatively expressed, sparse PCA is for unsupervised learning, and determines sparse eigenvectors that maximize the maximum eigenvalue (Rayleigh quotient) given a covariance matrix A. Sparse LDA is for supervised learning, and determines generalized eigenvectors that maximize the generalized maximum eigenvalue or generalized Rayleigh quotient, given a pair of covariance matrices A and B.

PCA can be viewed as a type of feature extraction (by linear combination of original variables), which is also used for visualization and data compression, whereas LDA is more suited for data clustering and classification (LDA is also obtained by linear combination of original variables). However, PCA maximally preserves the input data information (entropy), which makes reconstruction possible, whereas LDA only cares about enhancing class separability in its transformed space, which subsequently simplifies the task of computing decision boundaries for classification. Unlike PCA, the original data can not be reconstructed from its LDA representation. Therefore, LDA can not be used for data compression, but it still can be used for visualization.

It is desired to extend the general ideas of the sparse PCA method for the unsupervised case described in the related application to the supervised case of sparse LDA, which is traditionally cast as a generalized eigenvalue problem Ax=λ Bx, but now in a sparse form, where x represents input data, A and B are between-class and within-class covariance matrices respectively, and λ is an eigen value. In the special case of the within-class covariance matrix B being exactly equal to the identity matrix I, the proposed extension becomes equivalent to the previous related application of sparse PCA, i.e., this continuation-in-part application both extends and subsumes the related application, and includes it as a special case).

Feature selection is an important task for most automated classification processes. Generally, there are three types of feature selection methods: filters, wrappers and embedded techniques. In the filter method, the feature selection is independent and causally precedent to the classification stage. In the wrapper method, the feature selection is iteratively refined based on classifier outputs. In the embedded method, the feature selection is an essential component of classifier training.

Sparseness naturally constitutes one type of feature selection mechanism, which is typically incorporated by means of continuous optimization with L₁-norm penalty terms, and/or relevance prior probabilities. Representative examples include sparse regression, and sparse PCA (SPCA), from both supervised and unsupervised domains, respectively as described in the related application.

In supervised learning, the classification task is to “learn” a mapping function ƒ(x): [symbol] ⁿ→{±1} from a predetermined function class F and an unknown distribution of labeled training data pairs (x, y) such that unlabeled test with the same distribution are correctly classified.

The simplest function class is a linear perceptron: ƒ(x)=sign(w^{T}x+b), for which sparsity corresponds to a weight vector w with many zero elements, thereby indicating that only few of the variables xᵢ actually contribute to the decision rule ƒ(x). In the resulting lower-dimensional subspace, the variable subset selected forms a linear hyperplane, which then discriminates between the two classes.

A formulation of the Fisher linear discriminant is described by Mika et al., “A mathematical programming approach to the kernel fisher algorithm,” Advances in Neural Information Processing Systems 13, pp. 591-597), 2001. That formulation is a good example of an embedded variable selection technique. In general terms, it is formulated as the following nonlinear optimization problem,
min∥w∥ₚ^{p}+C∥ζ∥_{q}^{q}
subject to yᵢ(w^{T}xᵢ+b)=1−ζᵢ (1)
where C is a regularization (error tradeoff) parameter, w and b are the weight vector and bias of the linear perceptron ƒ(x), and the exponents p and q define the norms used to penalize the “size” of the weight and sparse vectors ξ, respectively. The case p=q=2 is its regularized form. By setting p=1, one can obtain the sparse Fisher discriminant (SFD). Note the similarity to the formulation of support vector machines (SVMs), where inequality constraints are replaced by equalities and positivity is enforced on the sparse vectors ξᵢ.

SVM training minimizes the L₂-norm of w (p=2) for a wide margin. Meanwhile, Karush-Kuhn-Tucker (KKT) complementarity leads to a sparse vector ξ, which is typically penalized with an L₁-norm (q=1). One key difference, from a classification standpoint, is that SVMs maximize a minimum margin, whereas the LDA-based discriminants tend to maximize an average margin.

In unsupervised learning, PCA is an essential tool for modeling and representation of data. Despite its power and popularity, a key drawback is the lack of sparseness, i.e., factor loadings are linear combinations of all the input variables. Sparse representations are generally desirable because they facilitate understanding, e.g., with gene expression data, reduce computational costs and can even promote better generalization. In machine learning, input sparseness is closely related to variable selection and automatic relevance determination.

A sparse PCA method for L₁-penalized regression on regular principal components is described by Zou, H., Hastie, T., and Tibshirani, R., “Sparse principal component analysis, Technical Report, Statistics Department, Stanford University, 2004.

Another method relaxes the “hard” cardinality constraint, d'Aspremont, A., Ghaoui, L. E., Jordan, M. I., & Lanckriet, G. R. G., “A direct formulation for sparse PCA using semi-definite programming,” Advances in Neural Information Processing Systems 17, pp. 803-809, 2004. That method uses a simpler convex approximation using semi-definite programming (SDP) for a more “direct” formulation called DSCPA.

In contrast, an alternative discrete spectral framework is described by Moghaddam, B., Weiss, Y., and Avidan, S., “Spectral Bounds for Sparse PCA: Exact & Greedy Algorithms,” Advances in Neural Information Processing Systems 18, pp. 915-922, 2006, see also the parent application. That method uses variational eigenvalue bounds on a covariance “sub-spectrum” as defined by the inclusion principle, which yields substantial performance gains using a simple greedy technique (GSPCA). In addition, an exact optimal algorithm (ESPCA) based on branch-and-bound search is described in complete detail in the parent application.

It is desired to extend that method to the supervised case of sparse LDA, which is cast as a generalized eigenvalue problem Ax=λBx, but now in a sparse form.

### SUMMARY OF THE INVENTION

The embodiments of the invention provide a discrete spectral framework for the sparse or cardinality-constrained solution of a generalized Rayleigh quotient. This NP-hard combinatorial optimization problem is central to supervised learning tasks such as sparse LDA, feature selection and relevance ranking for classification.

The embodiments of the invention provide a novel generalized form of the eigenvalue inclusion principle (IP) for variational bounds, leading to exact and optimal sparse linear discriminants using branch-and-bound search. An efficient greedy search technique that leads to an approximate result is also provided.

The method provides a novel feature selection filter, using only the 2^{nd} order statistics (covariances), as needed for (Fisher) linear discriminant analysis (LDA). The method provides a discrete spectral formulation based on variational modes of the Courant-Fischer “Min-Max” theorem for eigenvalue maximization, as specifically adapted to cardinality-constrained subspaces (variable subsets).

This approach is viewed as the logical (supervised) extension of the previous framework for sparse PCA described in the parent application using variational eigenvalue bounds, and thereby constitutes a more general formulation. That is, the sparse LDA method subsumes the sparse PCA method as a special case of sparse LDA.

As described previously, the discrete formulation reveals a simple post-processing renormalization step for improving any approximate solution, while providing bounds on its optimality. More important, the discrete approach leads to exact and provably optimal solutions using the branch and-bound search. The greedy and exact sparse LDA methods are applied to real-world datasets.

### BRIEF DESCRIPTION OF THE DRAWINGS

FIG. 1 is a block diagram of a maximized candidate solution to a combinatorial optimization problem using sparse LDA according to an embodiment of the invention;

FIG. 2 is a block diagram of a variational normalization procedure for sparse LDA according to an embodiment of the invention;

FIG. 3 is a block diagram of a greedy solution to a combinatorial optimization problem according to an embodiment of the invention;

FIG. 4 is a block diagram of a forward search for the greedy solution according to an embodiment of the invention;

FIG. 5 is a block diagram of a backward search for the greedy solution according to an embodiment of the invention; and

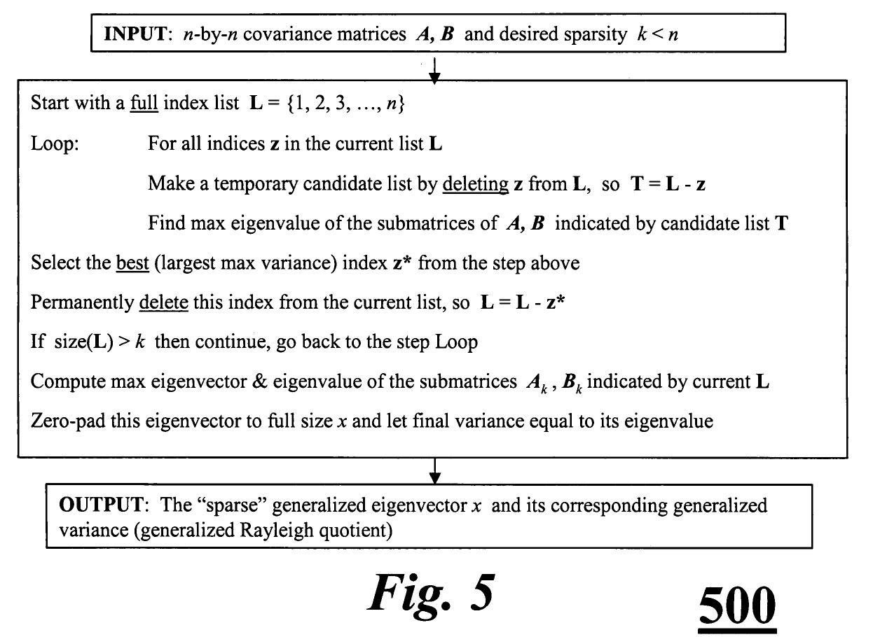

FIG. 6 is a block diagram of an exact solution to a combinatorial optimization problem according to an embodiment of the invention.

### DETAILED DESCRIPTION OF THE PREFERRED EMBODIMENT

One embodiment of our invention provides a method for performing sparse linear discriminant analysis (LDA) on data using spectral bounds. The sparse LDA can be used to find solutions to practical combinatorial optimization problems.

In contrast with the prior art, our invention uses a discrete formulation based on variational eigenvalue bounds. The method determines optimal sparse discimininants components using a greedy search for an approximate solution and a branch-and-bound search for an exact solution.

Maximized Candidate Solution

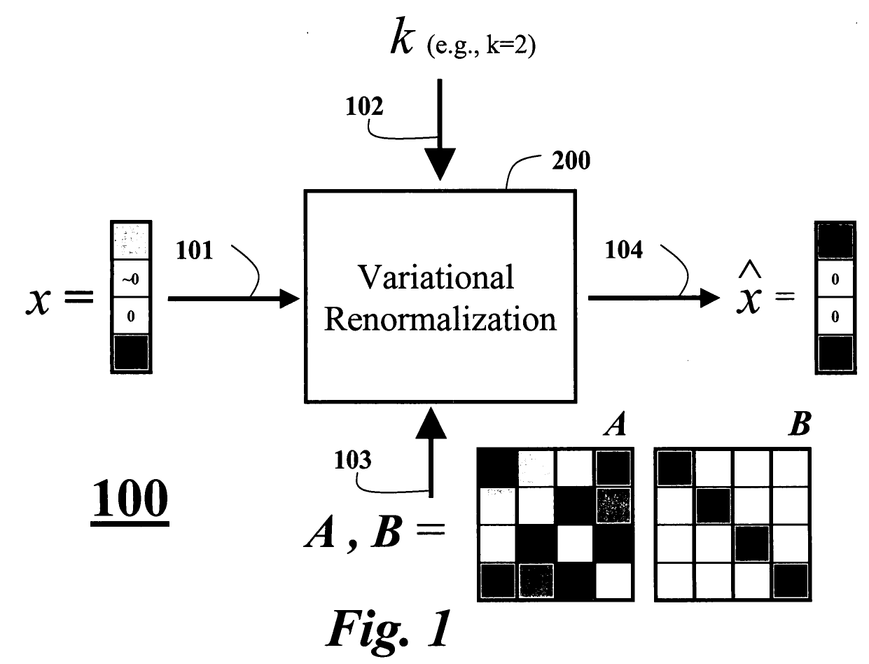

Using FIG. 1, we now describe a method 100 for improving a previously obtained candidate solution 101 to a practical combinatorial optimization problem of sparse LDA according to an embodiment of the invention. Inputs to the method are a data vector x 101 of elements, that is the candidate solution of the problem, a pair of covariance matrices A and B 103, and a sparsity parameter k 102. The sparsity parameter k denotes a maximum desired number of non-zero elements or “cardinality” of the final solution vector \hat{x} 104.

For example, the elements in the data vector x corresponds to an approximate sparse sonar signal, atmospheric signal, or biomedical data, investments data, and the like. The matrices A and B are between-class and within-class covariance matrices respectively.

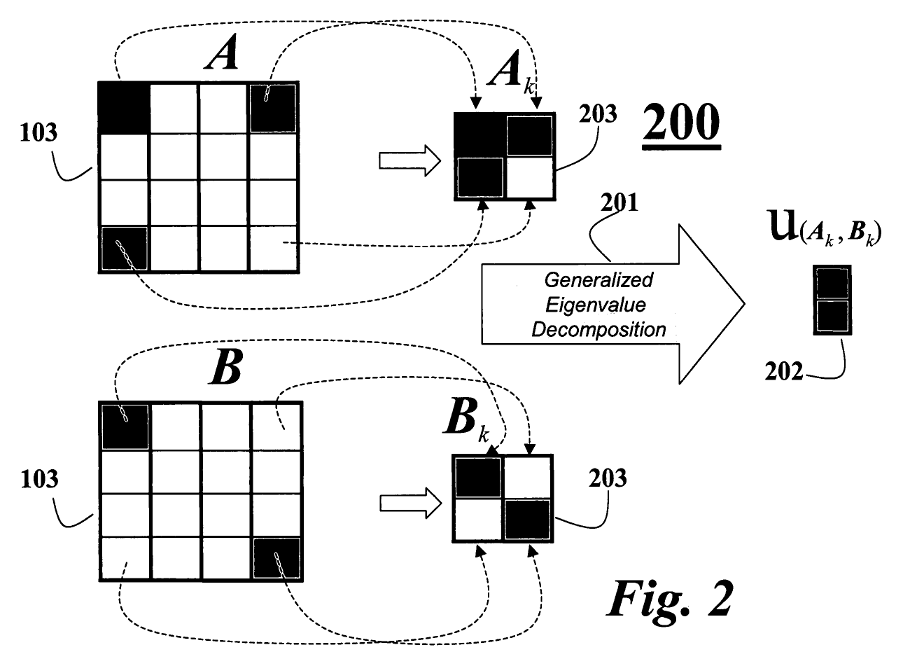

Variational renormalization 200 is performed according to the inputs to determine a maximized solution vector \hat{x} 104. As shown in FIG. 2, the variational renormalization 200 replaces the largest k elements 102 or “loadings” of the input data vector \hat{x} 101 with the k elements of the principal eigenvector u(Aₖ, Bₖ) 202 of the corresponding k×k principal submatrices Aₖ and Bₖ 203 with the largest generalized maximum-eigenvalue 201 (generalized Rayleigh quotient).

Greedy Search Solution

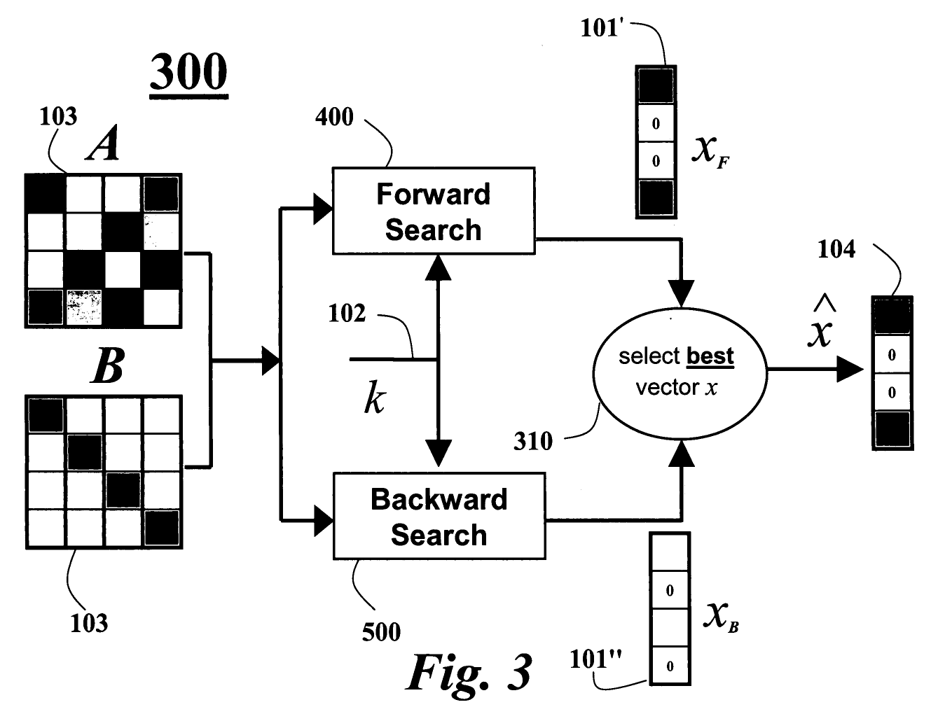

FIG. 3 shows the steps 300 of a greedy search solution to the sparse LDA optimization problem. Inputs to the method are the two covariance matrices 103 and the sparsity parameter k 102. Nested forward search 400 and backward search 500 are applied to obtain the candidate solution (s) with cardinality k, 101′-101″. From these two candidate solutions, the one with the greater variance (maximum generalized eigenvalue) is considered best 310 and selected as the output sparse eigenvector (final solution vector) \hat{x} 104.

Forward & Backward Search

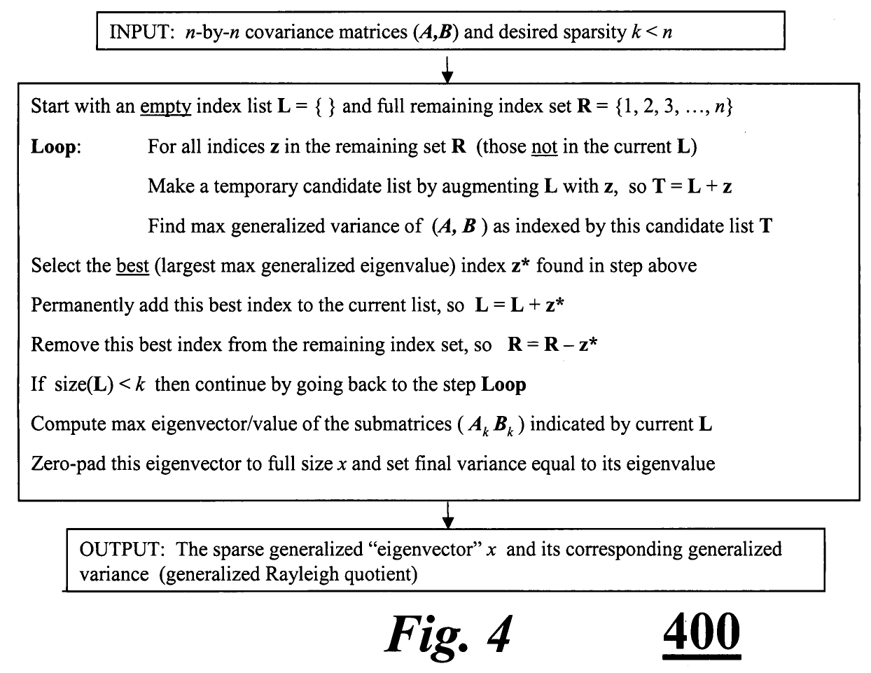

FIG. 4 shows the steps of the forward search 400. In this search, the list of candidate indices (elements of the x) is initially empty, and indices with the ‘best’ or largest maximum variance are added one by one up to a set size of k indices. The corresponding backward search 500 start with a full candidate index list, and indices are deleted one by one.

Exact Optimal Solution

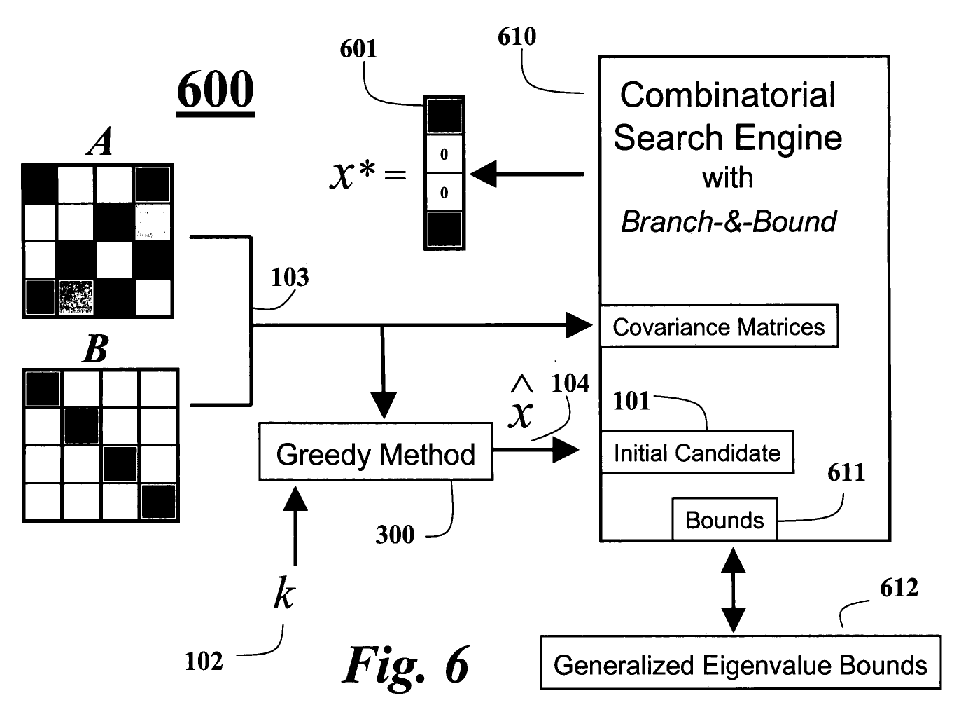

FIG. 6 shows the mechanism for exact solutions 600 to the sparse LDA problem. First, the bi-directional greedy method 300 is provided with the covariance matrices 103 and the desired sparsity parameter k 102 as before. The output solution of greedy search 300 provides an initial candidate solution \hat{x} 104 with its variance as an initial upper bound for subsequent use with a branch-and-bound combinatorial search 610, using the covariance matrices 103, and the eigenvalue bounds 611 as described in greater detail below. The branch-and-bound 610 is then guaranteed to find the exact optimal solution x* 601, when it terminates.

The embodiments of the invention are now described formally in greater detail.

Sparse LDA as a Generalized EVD

Classical Fisher or linear discriminant analysis (LDA) can be formulated as a generalized eigenvalue decomposition (EVD), where given a pair of symmetric, positive, semi-definite matrices A, B ε S₊ⁿ, corresponding to the between-class and within-class covariance matrices respectively.

We seek to maximize a class separability criterion represented by the generalized Rayleigh quotient: R(x; A, B)=(x^{T} Ax)/(x^{T}Bx) with x ε [symbol] ⁿ and B being positive definite. Because this quotient is invariant to the magnitude of x, we can reformulate the problem in terms of a quadratically constrained quadratic program (QCQP):
maxx^{T}Ax (2)
subject to x^{T}Bx=1.

Fortunately, this problem has a closed-form solution obtained by differentiating the corresponding Lagrangian multiplier, yielding Ax=λBx, with the determinantal characteristic equation det(A−λB)=0. Hence, the optimal x is the eigenvector corresponding to the largest root of the resulting characteristic polynomial in λ, or equivalently, the largest eigenvalue of B⁻¹A. Hereinafter, we denote eigenvalue rank in increasing order of magnitude, thus λₘᵢₙ=λ₁, and λₘₐₓ=λₙ.

We can define the sparse LDA optimization in terms of the following cardinality-constrained QCQP:

Sparse LDA:
maxx^{T}Ax (3)
subject to x^{T}Bx=1
card(x)=k,
where the solution is a sparse vector x ε [symbol] ⁿ having k non-zero elements, with card(x) being its L₀-norm. However, this optimization problem is non-convex, NP-hard and generally intractable.

Note that the special case of B=I defaults to a standard maximal-variance, cardinality-constrained QP, which is equivalent to a sparse PCA. Therefore, our strategy for the sparse LDA in Equation (3) also solves the sparse PCA.

To make this equivalence explicit, it is sufficient and instructive to view this generalized EVD as an ordinary eigenvalue problem in the non-singularly transformed space induced by a bijection y=B^{1/2}x. A function is bijective if and only if there is a one-to-one correspondence between both one-to-one (injective) and onto (surjective).
maxy^{T}Cy (4)
subject to y^{T}y=1
card(B^{-1/2}y)=k,
where C=B^{-1/2}AB^{-1/2}. Except for the cardinality constraint, this is a standard Rayleigh quotient in terms of the new symmetric matrix C, which has the same eigenvalues as B⁻¹A, but not the same eigenvectors. Without the cardinality constraint, this standard Rayleigh quotient obeys the analytic bounds
λₘᵢₙ(C)≦y^{T}Cy/y^{T}y≦λₘₐₓ(C),
where unlike B⁻¹A, the new matrix C is symmetric by construction.

Despite the odd cardinality constraint on B^{-1/2}y, the above reformulation can provide a useful method for adapting conventional sparse PCA method, e.g., SPCA according to Zou et al., or DSPCA according to d'Aspremont et al., to find sparse discriminant factors. To the best of our knowledge, this reformulation has not been described before.

Another and perhaps simpler alternative is to apply the equivalence of the Fisher linear discriminant to a least-squares regression, on suitably scaled output labels, and add an L₁-norm penalty term.

In contrast, we approach sparse LDA using the same discrete variational framework described by Moghaddam et al. in the parent application, motivated by the goal of finding exact and optimal discriminants, with optimality defined by the generalized Rayleigh quotient. We describe how the spectrum of the matrix C, and equivalently that of the inverse matrix B⁻¹ A plays a key role in the design of exact and optimal sparse LDA methods.

Optimality Conditions

First, we consider the conditions that must be true to reach an optimal solution. A sparse data vector x ε [symbol] ⁿ with cardinality k yields a maximum objective value R*. This necessarily implies that

$$R ( x ; A , B ) = \frac{{x}^{T} Ax}{{x}^{T} Bx} = \frac{{z}^{T} {A}_{k} z}{{z}^{T} {B}_{k} z} , \qquad ( 5 )$$

where z ε [symbol] ^{k} contains the k non-zero elements in the vector x and the matrices (Aₖ, Bₖ) are the k×k principal submatrices of (A, B) obtained by deleting the rows and columns corresponding to the zero indices of the vector x. This is equivalent to extracting the rows and columns of non-zero indices. The k-dimensional quadratic form in the vector z is equivalent to a standard unconstrained generalized Rayleigh quotient. This subproblem's maximum objective value is λₘₐₓ (Aₖ, Bₖ). Therefore, this must be the optimal objective value R*. We now summarize this key observation in the following proposition.

Proposition 1.

The optimal value R* of the sparse LDA optimization problem in Equation (3) is equal to λₘₐₓ(C*ₖ), where Cₖ^{def}=B^{-1/2}AₖB^{-1/2}ₖ is k×k, and C*ₖ in particular is the one submatrix pair with the largest maximal generalized eigenvalue. Moreover, the nonzero sub-vector z* of the optimal x* is equal to the inverse bijection of the principal eigenvector vₖ of C*ₖ
z*=B^{-1/2}ₖvₖ,v^{T}ₖC*ₖvₖ=λmax (C*ₖ) (6)

This reveals the true combinatorial nature of sparse LDA, and equivalent cardinality-constrained optimization problems, wherein solving for the optimal solution is inherently a discrete search for the k indices, which maximize λₘₐₓ of the subproblem (Aₖ, Bₖ).

While such an exact definition of optimality is illustrative, it does not suggest an efficient method for actually finding the optimal subproblem, short of an exhaustive search which is impractical for n>30, due to the exponential growth of candidate submatrices. Nevertheless, an exhaustive search is a viable method for small n that guarantees optimality for small real-world datasets, thus calibrating the quality of approximations via the optimality gap. Moreover, it suggests a simple but effective “fix” for improving approximate factors obtained by other methods, e.g., by SVMs.

Proposition 2.

Let \tilde{x} be a candidate solution with an approximate cardinality k found by any method. Let \tilde{z} be the non-zero subvector of \tilde{x} and vₖ be the principal generalized eigenvector of (Aₖ, Bₖ), as indexed by the non-zero indices of \tilde{x}. If \tilde{z} is not equal to vₖ(Aₖ, Bₖ), then \tilde{x} is not optimal. However, replacing \tilde{x}'s nonzero elements with vₖ in Equation (6) guarantees an increase in R(\tilde{x}, A, B).

This variational renormalization suggests that continuous solutions are only useful in providing a sparsity pattern with which to solve a smaller unconstrained, subproblem (Aₖ, Bₖ). In effect, their factor loadings are even more suboptimal than need be and should be replaced. Indeed, the common ad-hoc technique of “simple thresholding” (ST) for sparse PCA, i.e., setting the smallest absolute value loadings of the principal eigenvector to zero and re-normalizing it to unit-norm, can be enhanced by applying this “fix.”

Generalized Spectral Bounds for Sparse LDA

Variational Eigenvalue Bounds

The generalized eigenvalues of Ax=λBx play a fundamental role in defining sparse LDA factors of a given cardinality k, as the generalized eigenvalues associated with the principal submatrices (Aₖ, Bₖ). The two eigenvalue spectra can be related by the following result.

Theorem 1 Generalized Inclusion Principle.

Let the matrices (A, B) be n×n symmetric matrices with a generalized spectrum λᵢ(A, B), with the matrix B being positive definite. Let (Aₖ, Bₖ) be the corresponding pair of k×k principal submatrices (Aₖ, Bₖ), with 1 λk≦n having generalized eigenvalues λᵢ(Aₖ, Bₖ). Then for 1≦i≦k
λᵢ(A,B)≦λᵢ(Aₖ,Bₖ)≦λᵢ₊ₙ(A,B). (7)

The proof is given in Appendix A. The proof is an extension of a more basic proof for the original non-generalized eigenvalue inclusion principle, derived by imposing a sparsity pattern of cardinality k as an additional subspace orthogonality constraint in the variational form of the Courant-Fischer “Min-Max” theorem.

In other words, the generalized eigenvalues of (A, B) form upper and lower bounds for the generalized eigenvalues of all their principal submatrices (Aₖ, Bₖ). Therefore, the spectra of (Aₘ, Bₘ) and (Aₘ₊₁, Bₘ₊₁) interlace each other, with the eigenvalues of the larger matrix pair “bracketing” those of the smaller one. The well-known eigenvalue “interlacing” property comes from the basic inclusion principle with k=n−1.

For positive-definite symmetric matrices (covariances), augmenting Aₘ to Aₘ₊₁, by adding a new variable, always expands the spectral range, i.e., reducing λₘᵢₙ and increasing λₘₐₓ. This monotonicity property has important theoretical, as well as practical consequences for greedy and exact combinatorial processes, as described below. Because the solution of sparse LDA seeks to maximize the generalized Rayleigh quotient, the relevant inequality in Equation (7) has i=k, thus yielding the inclusion bounds
λₖ(A,B)≦λₘₐₓ(Aₖ,Bₖ)≦λn(A,B), (8)
which shows that the k^{th} smallest generalized eigenvalue of (A, B) is a lower bound for the class separability criterion of the sparse LDA with cardinality k. The eigenvalue bound λ(A, B) is also useful for speeding up branch-and-bound search with various predictive pruning techniques.

We note that the right-hand inequality in Equation (8) is a fixed, often loose, upper bound λₘₐₓ(A, B) for all k. However, branch-and-bound processes mostly work with intermediate sub-problems and will invariably encounter smaller submatrices with tighter bounds, which eventually fathom most branches of the search tree.

Combinatorial Optimization

In view of our discrete formulation and the generalized inclusion principle, conventional binary integer programming (IP) techniques, such as branch-and-bound are ideally suited for sparse LDA.

Greedy techniques like backward elimination can also exploit the monotonic nature of successively nested submatrices and their “bracketing” eigenvalues.

Start with the full index set I={1, 2, . . . , n}, sequentially delete the variable j that yields the maximum λₘₐₓ(A_{\j}, B_{\j}), until only k elements remain. For small cardinalities k<<n, the computational cost of backward search can grow to near maximum complexity ≈O(n⁴). Hence, its counterpart, forward selection, is often preferred. Start with the null index set I={ }, sequentially add the variable j that yields the maximum λmax(A₊ⱼ, B₊ⱼ), until k elements are selected. Forward search has worst-case complexity <O(n³). A powerful greedy strategy is a bi-directional search: Perform a forward pass, from 1 to n), and then perform a second independent backward pass from n to 1, and pick the better solution at each k. We call this dual-pass algorithm greedy sparse LDA or GSLDA.

Despite the expediency of near-optimal greedy search, it is nevertheless worthwhile to provide an optimal solution strategy, especially if the sparse LDA problem is in a critical application domain like bioinformatics, where even a small optimality gap can lead to costly diagnostic failures. Our branch-and-bound relies on computationally efficient bounds, in our case the upper bound in Equation(8) computable by the power method, for all active subproblems in a FIFO queue for depth-first search. The lower bound in Equation (8) can be used to sort the queue for a more efficient best-first search. Our exact sparse LDA method, called ESLDA, is guaranteed to terminate with the optimal discriminant.

Naturally, the total search time depends on the quality of the starting candidate in the branch-and-bound initialization. The solutions found by our dual-pass greedy search (GSLDA) are ideal for initializing the ESLDA, as their generalized Rayleigh quotient is typically near-optimal. In actual practice, preset thresholds based on generalized eigenvalue bounds can be used for early and premature termination at a desired solution.

Generalized Spectral Bounds for Sparse LDA

After extensive evaluation, we find that the most cost-effective strategy is to first perform GSLDA, or at least the forward pass, and then either settle for its near-optimal discriminant, or else use this discriminant to initialize ESLDA for a branch-and-bound search for the optimal discriminant. A full GSLDA has the added benefit of giving near-optimal solutions for all cardinalities, with running times that are typically far less demanding than finding a single-k approximation with most continuous methods, e.g., with SVMs.

Effect of the Invention

The embodiments of the invention provide a method for performing for sparse LDA, complete with requisite eigenvalue bounds and two discrete processes: a fast and effective greedy search (GSLDA), and a less efficient but optimal method (ESLDA). In addition, the invention provides a renormalization “fix” for any continuous approximation (relaxation). Indeed, the “straw-man” of simple thresholding (ST) was seen to be adequate, when fixed, naturally, but not always reliable. Note that because binary classification results in a rank-1 A matrix, it is mostly the eigen-structure of the within-class B matrix that governs the performance of continuous approximations. Discrete methods are not affected as much, as long as a small regularization term is added for numerical stability. It should be noted that sparse LDA is not restricted to binary classification.

A multi-factor form of the generalized Rayleigh quotient, with a matrix of factors X, can lead, for example, to a trace criterion, which as an eigenvalue sum can also be bounded using the generalized inclusion principle. In fact, any objective that can be formulated with eigenvalues alone, e.g., a log-determinant for entropy-based criteria, can be solved in discrete form using essentially the same processes.

The remarkable effectiveness of GSLDA is supported by empirical observations in combinatorial optimization, wherein greedy search with modular and monotonic cost functions very often produces excellent results.

The GSLDA consistently out-performed continuous processes such as simple thresholding (ST), and variable ranking by correlation. Although the computational burden is greater than such simple techniques, the methods compare favorably to more powerful continuous algorithms like SVMs. Nevertheless, processing very high-dimensional datasets, with n =O(10⁴), is generally beyond the reach of matrix-based processes without specialized numerical computing techniques.

The modularity of the invention and the ease of transition from the supervised domain (sparse LDA) to the unsupervised domain (sparse PCA), the default case of B=I. Indeed, almost no modification required in the derivations or implementation. Consequently, the sparse LDA automatically subsume the unsupervised case of sparse PCA.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

### Appendix A

We extend a basic proof of the standard eigenvalue inclusion principle to the generalized EVD of Ax=λBx using the Courant-Fischer “Min-Max” theorem, which is applied to the generalized Rayleigh quotient (x^{T}Ax=x^{T}Bx) instead.

Given a pair of symmetric matrices A, B, let λⱼ(A, B), for j=1, . . . , n, be their generalized eigenvalues ranked in increasing order. The main result establishes the following eigenvalue inequalities
λⱼ(A,B)≦λⱼ(Aₖ,Bₖ)≦λⱼ₊ₙ₋ₖ(A,B), (9)
where
λⱼ(Aₖ, Bₖ) are the generalized eigenvalues of corresponding principal submatrices of (A, B). By the Courant-Fischer “Min-Max” theorem, the generalized eigenvalues of (A, B) satisfy the variational form

$${λ}_{j} ( A , B ) = {min}_{{S}_{n}^{j}} {max}_{x ∈ {S}_{n}^{j}} \frac{{x}^{T} Ax}{{x}^{T} Bx} , \qquad ( 10 )$$

where S^{j}ₙ denotes an arbitrary j-dimensional subspace of [symbol] ⁿ. The same variational form holds independently for the generalized eigenvalues of (Aₖ, Bₖ)

$${λ}_{j} ( {A}_{k} , {B}_{k} ) = {min}_{{S}_{k}^{j}} {max}_{z ∈ {S}_{k}^{j}} \frac{{z}^{T} {A}_{k} z}{{z}^{T} {B}_{k} z} , \qquad ( 11 )$$

where S^{j}ₖ is an arbitrary j-dimensional subspace of [symbol] ⁿ. Next, we define a “sparse” j-dimensional subspace S^{j}₀ formed by the direct sum [symbol] ^{k}⊕0, which by definition includes all vectors x given by

$$x = [ \begin{matrix}z \\ 0\end{matrix} ] , where z ∈ {ℛ}^{k} \vert . \qquad ( 12 )$$

We now derive the l.h.s. inequality in Equation (9). The lower bound for the eigenvalues of (Aₖ, Bₖ), starting from the variational equality in Equation (10)

$$\begin{matrix}{λ}_{j} ( A , B ) = {min}_{{S}_{n}^{j}} & {max}_{x ∈ {S}_{n}^{j}} & \frac{{x}^{T} Ax}{{x}^{T} Bx} \\ \leq {min}_{{S}_{0}^{j}} & {max}_{x ∈ {S}_{0}^{j}} & \frac{{x}^{T} Ax}{{x}^{T} Bx} \\ = {min}_{{S}_{0}^{j}} & {max}_{x ∈ {S}_{0}^{j}} & \frac{{z}^{T} {A}_{k} z}{{z}^{T} {B}_{k} z} \\ = {λ}_{j} ( {A}_{k} , {B}_{k} ) & & \end{matrix} , \qquad ( 13 )$$

where in the 2nd line the subspace of x εS^{j}ₙ is restricted to x εS^{j}ₙ∩S^{j}₀, and because adding constraints can not further decrease the minimized expression, we obtain the inequality. The 3^{rd} line follows by definition of z as the leading k-dimensional subvector of S^{j}₀, and the last line follows from Equation(11).

The upper bound on λⱼ(Aₖ, Bₖ), the r.h.s. of Equation (9), is found by using this same exact derivation on the negation of the Rayleigh quotient. The proof is completed by noting that eigenvalues are invariant to permutation of the indices. Hence, the derived bounds hold true for any principal submatrix of (A, B) not just the leading one.

We claim:

1. A computer implemented method for maximizing candidate solutions to a cardinality-constrained combinatorial optimization problem of sparse linear discriminant analysis, comprising the steps of:
inputting a candidate sparse solution vector x with k non-zero elements, a pair of covariance matrices A, B measuring between-class and within-class covariance of input data to be classified, the sparsity parameter k denoting a desired cardinality of a final solution vector; and
performing a variational renormalization of the candidate solution vector x with regards to the pair of covariance matrices A, B and the sparsity parameter k to obtain a variance maximized discriminant eigenvector \hat{x} with cardinality k that is locally optimal for the sparsity parameter k and zero-pattern of the candidate sparse solution vector x, and is the final solution vector for the sparse linear discriminant analysis optimization problem.

2. The method of claim 1, in which the variational renormalization comprises:
replacing largest k elements of the candidate solution vector x with k elements of a principal generalized eigenvector u(Aₖ,Bₖ) of a corresponding pair of k×k principal submatrices Aₖ, Bₖ of the pair of covariance matrices A, B; and
setting all other elements of the candidate solution vector x to zero to obtain the variance maximized k-sparse eigenvector \hat{x}.

3. The method of claim 2, further comprising:
extracting the k×k principal submatrices Aₖ, Bₖ from rows and columns of the pair of covariance matrices A, B.

4. The method of claim 2, in which the k non-zero values of the variance maximized k-sparse eigenvector \hat{x} are exactly equal to the k entries of a principal generalized eigenvector u*ₖ, which corresponds to a maximum eigenvalue of the k×k the principal submatrices Aₖ, Bₖ.

5. The method of claim 1, in which the elements are a relatively small number of the input data selected from a substantially larger pool of input data.

6. The method of claim 1, in which the sparsity parameter k is at least equal to a rank of a generalized eigenvalue of the pair of covariance matrices A, B that is nearest in magnitude to a minimal required generalized Rayleigh quotient for the maximized k-sparse generalized eigenvector \hat{x}.

7. A computer implemented method for solving a cardinality-constrained combinatorial optimization problem of sparse linear discriminant analysis, comprising the steps of:
inputting a covariance matrix pair A, B measuring between-class and within-class covariances of data for sparse linear discriminant analysis optimization problem, and a sparsity parameter k; and
performing a greedy search to determine a final solution vector.

8. The method of claim 7, in which the greedy search includes a bi-directional nested search including a forward search and an independent backward search, and further comprising:
selecting separately for the sparsity parameter k a best sparse eigenvector from either the forward search or the backward search as the variance maximized k-sparse eigenvector.

9. A computer implemented method for solving a cardinality-constrained combinatorial optimization problem of sparse linear discriminant analysis, comprising the steps of:
inputting a covariance matrix pair A, B measuring between-class and within-class covariances of input data for sparse linear discriminant analysis optimization problem, and a sparsity parameter k;
providing a candidate solution vector x of elements; and
applying a branch-and-bound combinatorial search using the candidate solution vector x to obtain a globally optimal exact solution vector x* for the cardinality-constrained combinatorial optimization problem defined by the pair of covariance matrices A, B and the sparsity parameter k.

10. The method of claim 9, in which the candidate solution is a result of greedy search where the input data for the greedy search is the covariance matrix pair A, B and the sparsity parameter k;

11. The method of claim 9, in which the branch-and-bound combinatorial search uses generalized eigenvalue bounds for pruning sub-problem branching paths in a search tree.

12. The method of claim 9, in which the sparsity parameter k is at least equal to a rank of a generalized eigenvalue of the pair of covariance matrices A, B nearest in magnitude to a minimal required variance for the maximized k-sparse generalized eigenvector \hat{x}.

13. The method of claim 1, in which the matrix B is an identity matrix to perform a principal component analysis.
